(19) United States
(12) Patent Application Publication
(10) Pub. No.: US 2017/0113450 A1
(43) Pub. Date: Apr. 27, 2017

(54) METHOD FOR PROVIDING DATA

(71) Applicant: HARTING ELECTRIC GMBH & CO. KG, Espelkamp (DE)

(72) Inventors: Andreas Nass, Warmsen (DE); Claus Hilger, Solms (DE); Thorsten Meyer, Brockum (DE)

(21) Appl. No.: 15/306,046

(22) PCT Filed: May 7, 2015
(86) PCT No.: PCT/DE2015/100184

§ 371 Date: Oct. 21, 2016

(30) Foreign Application Priority Data
Jul. 18, 2014 (DE) 10 2014 110 156.1

(51) Int. Cl. B33Y 50/02; G05B 19/042; B29C 67/00

(52) U.S. Cl. CPC B33Y 50/02; B29C 67/0088; G05B 19/042; G05B 2219/49023

(57) ABSTRACT

Provided is a method wherein data are downloaded via a network and/or via a suitable platform via the internet, and fed into a 3D printer, wherein the 3D printer subsequently prints out a component and/or a blank component of a connector. Using a method of this type, a customer can adapt connectors to a machine design and also add additional technical components, if necessary, for example, sensors and displays.

The invention is based on a method for providing data according to the preamble of the independent claim 1.

Methods of this type provide data about components and/or finished components which are in particular used in machine construction.

### PRIOR ART

EP 1 429 911 B1 shows a 3-D printer which is suitable for printing three-dimensional components. By using such a printer, for example component parts or components for machines can be provided provisionally.

The functionality of component parts printed out in this manner does not correspond to the original component, however.

### STATEMENT OF THE OBJECT

The object of the invention is to propose a method for providing data for use in a 3-D printer, the components from which can be used in the long term.

The object is achieved by the characterizing features of the independent claim 1.

Advantageous refinements of the invention are specified in the dependent claims.

In the method for providing data as it is proposed here, the data is provided by a manufacturer, via a network and/or via a suitable platform, via the Internet and can be downloaded by a customer.

The downloaded data is fed into a 3-D printer. The 3-D printer then prints out a component. Alternatively, a blank can be printed with the aid of the data. The blank is advantageously supplied or provided by the provider of the data. The geometry of the blank is then contained in the downloaded data.

In order to be able to print a blank better, a 3-D printer is advantageously equipped with a three-dimensionally movable holding arm, which carries the blank. The holding arm can then always position the blank in relation to the nozzles of the 3-D printer such that printing is possible. As a result, the three-dimensional blank can also be printed three-dimensionally—that is to say from all sides and, in the case of plug connector housings, also from the inside.

By means of the rapid provision of suitable data, for example design times can be reduced.

The component printed out and/or the printed blank forms a component part of a plug connector. Multiple component parts can then in total form a complete plug connector. For this purpose, it would be necessary for various materials, conductive and non-conductive materials, to be printed. This can be done via a single 3-D printer or via multiple different 3-D printers.

It is advantageous for the method according to the invention to connect a plastic 3-D printer and a metal 3-D printer in series. The plastic and metal component parts of the component can then each be produced by the specialized printers. The respectively semifinished component parts are then transferred from one printer to the other printer.

Advantageously, the data is an original data set, which can be expanded by a customer data set. The original data set includes the absolutely necessary data about the component. This data is, for example, safety-relevant. Without complying with this data, a product containing this component should not be marketed and operated. This necessary data is non-modifiable.

The original data set can be expanded by the customer data set. The customer data set permits individual styling of the component. The individual styling can be, for example, the placing of a customer company logo on the plug connector housing. However, it is also possible for company-specific or product-specific design elements to be implemented. As a result, the customer can adapt the plug connector individually to his product, for example to a machine.

Advantageously, the component is used to replace a defective plug connector component, as a so-called spare part. As a result, stoppages of machines can be eliminated quickly and ideally avoided preventatively.

However, the component can also be a plug connector housing. The interior of the plug connector, in particular the insulating body and the contact elements, are supplied by the plug connector manufacturer. By using the transmitted data, the customer can print out a housing and, if appropriate, provide the latter with his own design, including his own logo.

However, the customer could also obtain data about the insulating body, print the latter himself and fit the insulating body with contact elements from the manufacturer or data supplier.

The customer can include the data obtained in good time in his development and, for example, incorporate it in CAD models. As a result, the development time of the customer is reduced.

The invention likewise relates to a blank which can be used in the above-described method. This means that the data set must at least implicitly contain the geometry of the blank. Advantageously, the blank has interfaces which can be addressed via the customer data set. These interfaces are areas which can be individualized by the customer data set.

The blank advantageously has technical interfaces and design interfaces. The design interfaces can be used to attach design elements, as described above using the example of a housing.

The technical interfaces are suitable for attaching technical component parts to the component. For example, a plug connector housing can be provided with a display or a touch screen. Here, for example, the technical element is placed on the blank and overprinted by the 3-D printer and thus connected to the blank.

The interfaces belonging to the blank can also be used by the customer without 3-D printing. All the technical and safety-relevant characteristics are satisfied by the blank. The interfaces are advantageously areas on the surface of the blank which can be printed by a 3-D printer, and the applied material adheres to the surface well and in a long-lasting manner. The surface finish of these areas is coordinated with a 3-D print.

Advantageously, the surface of the interfaces has a mean roughness between 1 and 10 μm. 3-D prints made of plastic material adhere particularly well to such a rough surface.

The surface of the interfaces is also targeted to the 3-D print in terms of the material finish.

It is advantageous to configure the data provided to be available for a limited time. The customer is not intended to be able to use the data for an infinitely long time. For example, before the use of the data, it would be possible to interrogate a license file which determines the period of use of the data. Alternatively or additionally, the license file could contain the maximum number of printable component parts. By means of the measure, the data provider could ensure that his data is usable as a function of time and/or number of parts. The data is usable in a time-limited manner, that is to say only temporarily.

In one advantageous embodiment of the invention, a 3-D printer which is able to process both plastic materials and metallic (conductive) materials is involved. As a result, the 3-D printer can, for example, expand a plastic blank with metallic component parts and/or complete a metal blank with plastic elements. For example, in this way a metallic plug connector housing could be equipped with an insulating body and contact elements located therein.

In the following text, the core of the invention will be summarized once again. In machine construction, there is a trend to equip proprietary machines with a company-specific design in order to produce manufacturer affiliation in the customer. The individual design should ideally be mirrored in each individual component part of the machine. Until now, this has been difficult in the case of supplier parts. The invention therefore relates to a method for providing data, wherein the data is downloaded via a network and/or via a suitable platform via the Internet, wherein the data is fed into a 3-D printer, wherein the 3-D printer then prints out a component and/or a blank and wherein the component and/or the printed blank is a component part of a plug connector.

Via such a method, the customer can also adapt plug connectors to the machine design and, if appropriate, also add further technical component parts, for example sensors and display. The know-how and the safety-relevant aspects are further covered by the plug connector manufacturer.

1. A method for providing data for producing a component part of a plug connector, wherein the data is downloaded via a network and/or via a suitable platform via the Internet,
wherein
the data is fed into a 3-D printer,
the 3-D printer then prints out a component and/or prints a blank,
and the component and/or the printed blank is a component part of a plug connector.

2. The method for providing data as claimed in claim 1, wherein
the data is an original data set, which can be expanded by a customer data set.

3. The method for providing data as claimed in claim 1,
wherein
the original data set contains the absolutely necessary data about the component and cannot be modified
and the customer data set is used for the individual styling of the

4. The method for providing data as claimed in claim 1 wherein
the component is used to replace a defective plug connector component part, as a so-called spare part.

5. The method for providing data as claimed in claim 1
wherein
the component is a housing of a plug connector.

6. The method for providing data as claimed in claim 1
wherein
the data is usable in a time-limited temporary manner.

7. The method for providing data as claimed in claim 1
wherein
both plastic materials and metallic materials can be processed with the 3-D printer.

8. A blank for use in a method as claimed in claim 1.

9. The blank as claimed in claim 8, wherein the
the blank has interfaces which can be addressed via the customer data set.

10. The blank as claimed in claim 8, wherein
the interfaces are technical interfaces and design interfaces.

11. The blank as claimed in claim 8, wherein
the technical interfaces are suitable to receive a technical component, and example a sensor or a display,
the design interfaces are suitable for the individual design styling of the component.

12. The method for providing data as claimed in claim 1, wherein the data is usable in a limited manner such that a maximum number of components can be printed out with the data.

13. The blank as claimed in claim 11, wherein the technical interfaces are suitable to receive a sensor or a display.

14. The blank as claimed in claim 11, wherein the design interfaces are suitable for placing a company logo.
